(19) United States
(12) Patent Application Publication
(10) Pub. No.: US 2011/0193937 A1
(43) Pub. Date: Aug. 11, 2011

(54) IMAGE PROCESSING APPARATUS AND METHOD, AND IMAGE PRODUCING APPARATUS, METHOD AND PROGRAM

(76) Inventors: Mikio Watanabe, Miyagi (JP); Satoshi Nakamura, Miyagi (JP); Kouichi Yahagi, Miyagi (JP)

(21) Appl. No.: 13/122,875

(22) PCT Filed: Oct. 8, 2009
(86) PCT No.: PCT/JP2009/005240

§ 371 Date: Apr. 6, 2011

(51) Int. Cl. H04N 13/00; G06K 9/00

(52) U.S. Cl. 348/43; 382/154; 348/E13.001

(57) ABSTRACT

An image reproducing apparatus (and method) includes obtaining a plurality of original images of a subject viewed from different viewpoints for generating a three-dimensional image, generating at least one interpolation image from the plurality of original images for interpolating a viewpoint between at least the plurality of original images, generating a motion picture in which the plurality of original images and at least some of the interpolation images are arranged in the order of viewpoint, and storing the plurality of original images and the motion picture in relation to each other.

### TECHNICAL FIELD

The present invention relates to an image processing apparatus and method for generating an interpolation image for interpolating a viewpoint between each of a plurality of original images of a subject viewed from different viewpoints. The invention also relates to a program for causing a computer to perform the image processing method.

### BACKGROUND ART

A stereoscopically viewable three-dimensional image that makes use of parallax may be obtained by performing photographing using a compound eye photographing device, such as a stereo camera, that obtains images using at least a pair of photographing means disposed at different positions. Such a compound eye photographing device obtains two images (left and right) by photographing the same subject from different viewpoints by giving a convergence angle to the optical axes of the pair of photographing means, and a stereoscopically viewable three-dimensional image is produced from the two images using the parallax.

In the mean time, when reproducing an image stored in a medium on a personal computer or the like, it is customary that a list of thumbnails of stored images is reproduced. The user may select an image from the thumbnail list to display it on the monitor of the personal computer in an enlarged form. Here, a method is proposed in which, when a motion picture is stored, one scene of the motion picture is displayed in the thumbnail image list and the motion picture is reproduced by selecting the thumbnail image of the motion picture as described, for example, in Japanese Unexamined Patent Publication No. 10 (1998)-108123.

Where a plurality of two-dimensional images, including a three-dimensional image generated in the manner described above, is stored in a medium, and if the list of thumbnail images is displayed, then for the three-dimensional image, any one of a plurality of original images for reproducing the three-dimensional image is included in the list screen. In this case, the user may stereoscopically display the three-dimensional image by selecting the thumbnail image. But, the three-dimensional image is a still image and it is difficult to distinguish between a three-dimensional image and a two-dimensional image only from the list of thumbnail images.

The present invention has been developed in view of the circumstances described above, and it is an object of the present invention to make a three-dimensional image easily recognizable, in particular when three-dimensional images and two-dimensional images are stored in a mixed manner.

### DISCLOSURE OF INVENTION

An image processing apparatus of the present invention is an apparatus, including:

an image obtaining means for obtaining a plurality of original images of a subject viewed from different viewpoints for generating a three-dimensional image;

an interpolation image generation means for generating at least one interpolation image for interpolating a viewpoint between at least the plurality of original images;

a motion picture generation means for generating a motion picture in which the plurality of original images and at least some of the at least one interpolation image are arranged in the order of viewpoint; and

a storage means for storing the plurality of original images and the motion picture in relation to each other.

The term “interpolating a viewpoint between at least the plurality of original images” as used herein refers to that a viewpoint not only between the plurality of original images but also outside of an original image viewed from the outermost viewpoint is interpolated.

The term “generating a motion picture in which the plurality of original images and at least some of the at least one interpolation image are arranged in the order of viewpoint” as used herein includes not only the case in which the motion picture is generated using all of the original images and interpolation images but also the case in which the motion picture is generated using all of the original images and some of the interpolation images or, for example, only interpolation images.

The motion picture may be a motion picture for thumbnail display.

The term “storing the plurality of original images and the motion picture in relation to each other” as used herein refers to that the plurality of original images and the motion picture are in inseparable relation in terms of management. More specifically, the plurality of original images and the motion picture may be stored in relation to each other by various methods, such as storing the plurality of original images and the motion picture in the same folder, giving a common file name to the plurality of original images and the motion picture, storing information indicating that the plurality of original images and the motion picture are related to each other, storing the plurality of original images and the motion picture in a single file, recording, in at least one of the header areas of the plurality of original images and the motion picture, a file name of another image, and the like. Note that even when the plurality of original images and the motion picture is stored in relation to each other, access only to the original images or the motion picture and the like are allowed.

In the image processing apparatus of the present invention, the interpolation image generation means may be a means that determines the number of interpolation images such that the motion picture is reproduced for a predetermined time.

Further, in the image processing apparatus of the present invention, the storage means may be a means that stores the plurality of original images and the motion picture as separate image files with a relational information file that includes information indicating that the image file of the plurality of original images and the image file of the motion picture are related to each other and the motion picture is an image representing the plurality of original images.

Still further, in the image processing apparatus of the present invention, the storage means may be a means that stores the plurality of original images and the motion picture as a single image file together with information indicating that the motion picture is an image representing the plurality of original images.

An image reproducing apparatus of the present invention is an apparatus for reproducing various types of images, including the plurality of original images stored by the image processing apparatus of the present invention,

wherein the image reproducing apparatus includes a reproducing means for reproducing the motion picture when an instruction to perform a two-dimensional display is received for a three-dimensional image generated from the plurality of original images.

In the image reproducing apparatus of the present invention, the reproducing means may be a means that endlessly reproduces the motion picture.

An image processing method of the present invention is a method, including the steps of:

obtaining a plurality of original images of a subject viewed from different viewpoints for generating a three-dimensional image;

generating at least one interpolation image for interpolating a viewpoint between at least the plurality of original images;

generating a motion picture in which the plurality of original images and at least some of the at least one interpolation image are arranged in the order of viewpoint; and

storing the plurality of original images and the motion picture in relation to each other.

An image reproducing method of the present invention is a method for reproducing various types of images, including the plurality of original images stored by the image processing method of the present invention,

wherein the method reproduces the motion picture when an instruction to perform a two-dimensional display is received for a three-dimensional image generated from the plurality of original images.

Each of the image processing method and image reproducing method of the present invention may be provided as a program that causes a computer to perform the method.

According to the present invention, from a plurality of original images, at least one interpolation image for interpolating a viewpoint between at least the plurality of original images is generated. Then, a motion picture in which the plurality of original images and at least some of the at least one interpolation image are arranged in the order of viewpoint is generated, and the plurality of original images and the motion picture are stored in relation to each other. Consequently, by reproducing a motion picture when a three-dimensional image is displayed, scenes in which viewpoints toward a subject sequentially vary are reproduced. This allows the user to easily recognize which one is the three-dimensional image from the displayed thumbnail image list, in particular when a stereoscopically viewable three-dimensional image generated from a plurality of original images and other two-dimensional image are stored in a mixed manner.

Further, the motion picture may be reproduced for a predetermined time by determining the number of interpolation images such that the motion picture is reproduced for the predetermined time.

The image file of the motion picture may be generated in a general file format which can be easily handled by a personal computer or the like by storing the three-dimensional image and motion picture as separate image files with a relational information file that includes information indicating that the image file of the three-dimensional image and the image file of the motion picture are related to each other and the motion picture is an image representing the plurality of original images. Therefore, the motion picture may be reproduced easily.

The plurality of original images and the motion picture related to each other may be prevented from disorder by storing the plurality of original images and the motion picture as a single image file together with information indicating that the motion picture is an image representing the plurality of original images.

### BRIEF DESCRIPTION OF DRAWINGS

FIG. 1 is a schematic block diagram of a compound eye photographing device to which an image processing apparatus and an image reproducing apparatus according to an embodiment of the present invention are applied, illustrating the configuration thereof.

FIG. 2 is a schematic block diagram of a photographing unit, illustrating the configuration thereof.

FIG. 3 illustrates the disposition of the photographing units.

FIG. 4 illustrates original images.

FIG. 5 illustrates the generation of interpolation images.

FIG. 6 illustrates the relationship between a solid shape model and image projection planes from which original images are obtained.

FIG. 7 illustrates a file structure of a three-dimensional image file of the present embodiment.

FIG. 8 illustrates a file structure of a motion picture file of the present embodiment.

FIG. 9 illustrates a descriptive content of a relational information file.

FIG. 10 is a flowchart illustrating processing performed in the present embodiment for generating files.

FIG. 11 illustrates the record states of a three-dimensional image file, a motion picture image file, and a relational information file.

FIG. 12 is a flowchart illustrating processing performed in the present embodiment for displaying a list of thumbnail images.

FIG. 13 illustrates a list screen of thumbnail images.

FIG. 14 illustrates a file structure of a file in which original images and a motion picture according to the present embodiment are stored.

### BEST MODE FOR CARRYING OUT THE INVENTION

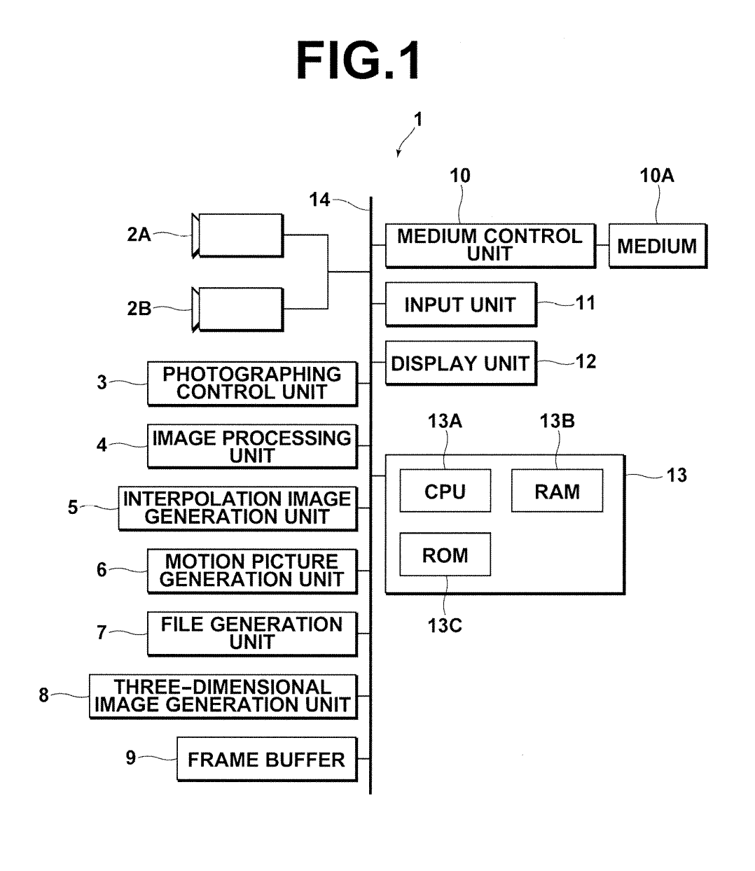

Hereinafter, an embodiment of the present invention will be described with reference to the accompanying drawings. FIG. 1 is a schematic block diagram of a compound eye photographing device to which an image processing apparatus and an image reproducing apparatus according to an embodiment of the present invention are applied, illustrating the configuration thereof. As illustrated in FIG. 1, Compound eye photographing device 1 according to the present embodiment includes two photographing units 2A, 2B, photographing control unit 3, image processing unit 4, interpolation image generation unit 5, motion picture generation unit 6, file generation unit 7, three-dimensional image generation unit 8, frame buffer 9, medium control unit 10, input unit 11 constituted by operation buttons for performing various types of input operations, display unit 12, such as a liquid crystal display, for displaying various types of information, control unit 13, and bus 14 connecting each unit.

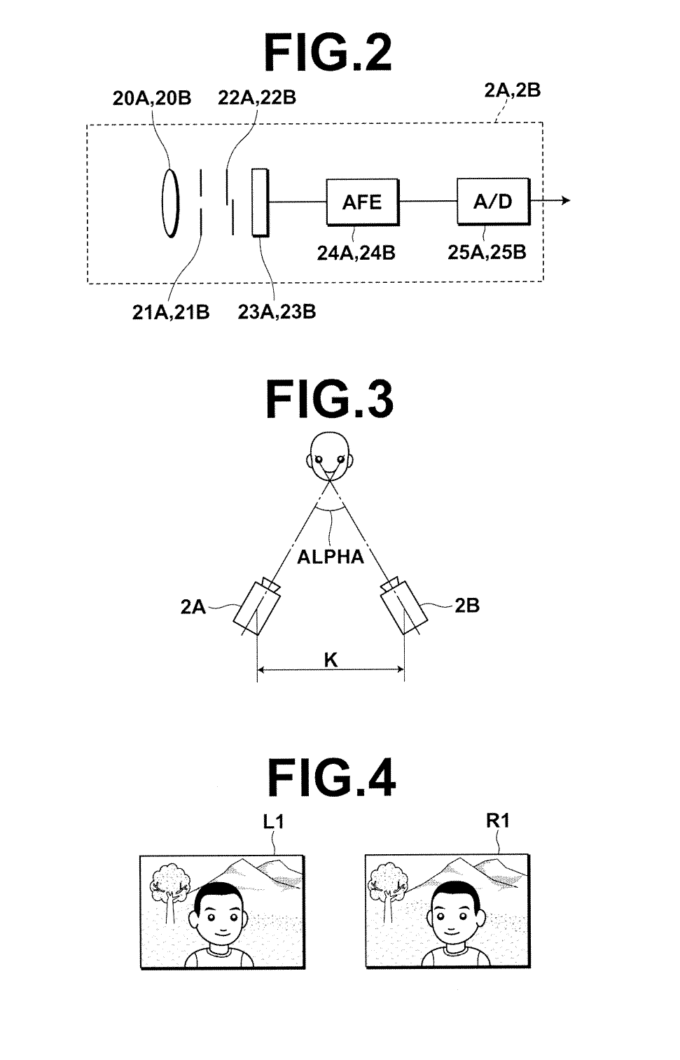

FIG. 2 illustrates the configuration of photographing unit 2A or 2B. As shown in FIG. 2, photographing units 2A and 2B include lenses 20A, 20B, apertures 21A, 21B, shutters 22A, 22B, CCDs 23A, 23B, analog front ends (AFE) 24A, 24B, and A/D conversion units 25A, 25B respectively. Photographing units 2A, 2B are disposed so as to have predetermined base length K with convergence angle α toward a subject, as illustrated in FIG. 3. Information of convergence angle α and base length K is stored in ROM 12C, to be described later.

Each of lenses 20A, 20B includes a plurality of functional lenses, such as a focus lens for bringing a subject into focus, a zoom lens for realizing a zoom function and the like, and positions of the lenses are controlled by a not shown lens drive unit based on focus data obtained by AF processing performed by photographing control unit 3 and zoom data obtained by operating a not shown zoom lever.

The aperture diameter of each of apertures 21A, 21B is controlled by a not shown aperture drive unit based on the aperture value data obtained by AE processing performed by photographing control unit 3.

Each of shutters 22A, 22B is a mechanical shutter and driven by a not shown shutter drive unit according to the shutter speed obtained by AE processing.

Each of CCDs 23A, 23B includes a photoelectric surface that has multiple light receiving elements disposed two-dimensionally, and a light image representing a subject is formed on the photoelectric surface and subjected to photoelectric conversion, whereby an analog image signal is obtained. A color filter having R, G, and B filters disposed regularly is provided in front of each of CCDs 23A, 23B.

AFEs 24A, 24B perform processing on the analog image signals outputted from CODs 23A, 23B respectively for removing noise and adjusting gain (analog processing).

A/D conversion units 25A, 25B convert the analog image signals analog-processed by AFEs 24A, 24B respectively. Images represented by digital image data obtained by photographing unit 2A, 2B are referred to as images L1, L2 respectively.

Photographing control unit 3 is constituted by not shown AF and AE processing units. The AF processing unit determines the focal length of lenses 20A, 20B based on pre-images obtained by photographing units 2A, 2B in response to a halfway depression of a release button included in input unit 11, and outputs the determined value to photographing units 2A, 2B. The AE processing unit determines the aperture value and shutter speed based on the pre-images and outputs the determined values to photographing units 2A, 2B. It is also possible to perform photographing using predetermined focus position, aperture value, and shutter speed.

Photographing control unit 3 also gives an instruction to photographing units 2A, 2B to obtain main images of images L1, R1 for generating a three-dimensional image in response to a full depression of the release button included in input unit 11. Before the release button is operated, photographing control unit 3 gives an instruction to photographing units 2A, 2B to obtain through images of less number of pixels than that of the main images for confirming the photographing ranges.

Here, as shown in FIG. 3, images L1, R1 are images obtained by photographing a subject at two different photographing positions, and images included in images L1, R1 have a parallax according to the difference in the photographing position, as shown in FIG. 4. Images L1, R1 are obtained at photographing positions of photographing units 2A, 2B, i.e., at photographing positions on the left and right toward the subject respectively, and a three-dimensional image is generated based on images L1, R1. As such, images L1, R1 are, hereinafter, referred to as original images L1, R1. Note that when a three-dimensional image is generated, the image displayed on the left is referred to as image L1 and the image displayed on the right is referred to as Image R1.

In the present embodiment, a stereoscopically viewable three-dimensional image is generated from two original images, L1 and R1, but an arrangement may be adopted in which three or more photographing units are provided and a stereoscopically viewable three-dimensional image is generated from three or more original images obtained by performing photographing at three or more different photographing positions.

Image processing unit 4 performs image quality correction processing on digital image data of original images L1, R1 obtained by photographing units 2A, 2B. Such image quality correction processing includes correction processing for correcting a difference in the angle of view between photographing units 2A, 2B, a difference in zoom magnification between photographing units 2A, 2B, image displacement due to rotation of the CCDs, a trapezoidal distortion caused by photographing a subject with convergence angle α between photographing units 2A, 2B, in addition to white balance correction, gray level correction, sharpness correction, color correction, and the like. Note that the same symbols L1, R1 are used for original images after processed by image processing unit 4.

Interpolation image generation unit 5 generates at least one interpolation image from original images L1, R1 obtained by photographing or from original images L1, R1 obtained by photographing in advance and stored in medium 10A. In the present embodiment, interpolation image generation unit 5 generates several interpolation images m which can be reproduced during a predetermined time t when a motion picture constituted by original images L1, R1 and the interpolation images is reproduced at a frame rate of 30 frames per second, to be described later.

Interpolation image generation unit 5 obtains a minimum value of m that satisfies the relationship, 30×t≦m+2, as the number of interpolations. For example, if t=2, a total of 60 frames of original images L1, R1 and interpolation images is required, thus resulting in m=58. In this case, interpolation image generation unit 5 generates 58 interpolation images.

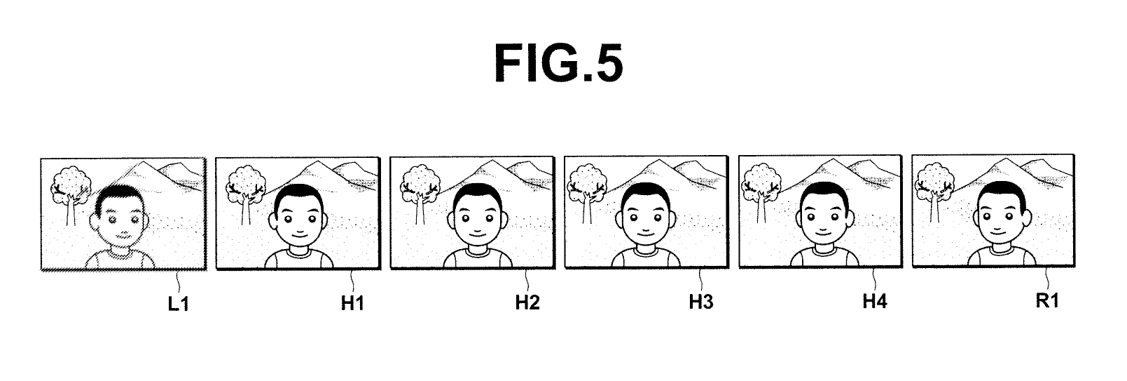

FIG. 5 illustrates the generation of interpolation images. As shown in FIG. 5, interpolation image generation unit 5 generates m interpolation images H1 to Hm (m=4 in FIG. 5) from original images L1, R1. Interpolation image generation unit 5 generates interpolation images H1 to Hm such that, if it is assumed that interpolation images Hk were obtained by photographing, convergence angles between the photographing units correspond to each other when original image L1 and interpolation image H1 are obtained, when interpolation image Hk (k=1 to m) and interpolation image Hk+1 are obtained, and when interpolation image Hm and original image R1 are obtained.

Here, interpolation image generation unit 5 generates interpolation images H1, H2 by morphing original images L1, R1 such that the parallax between corresponding pixels included in original images L1, R1 is gradually reduced. More specifically, interpolation images H1, H2 are generated by detecting corresponding points corresponding to each other in left and right images, connecting the corresponding points by a straight or curved line, calculating a pseudo corresponding point by dividing the straight or curved line, and deforming original images L1, R1 so as to correspond to the pseudo corresponding point. Further, any known method, such as that described in Japanese Unexamined Patent Publication No. 2002-190020 and the like, may also be used.

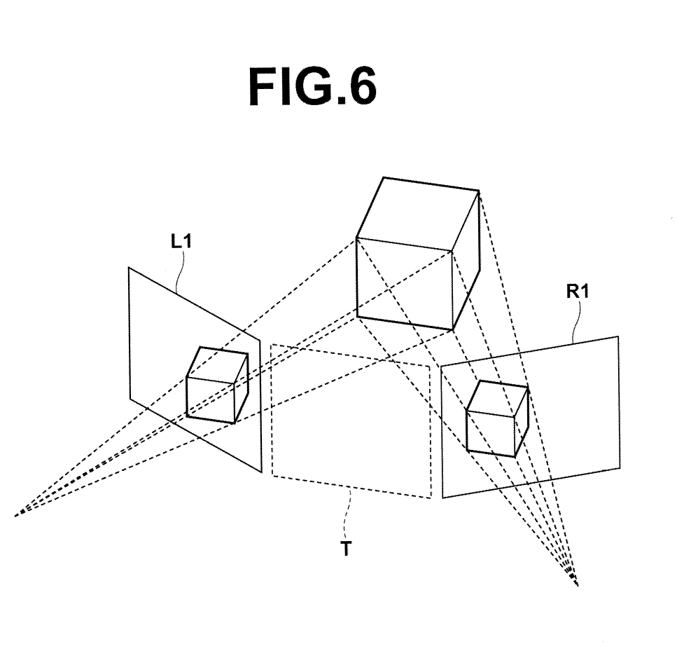

The interpolation images may be generated by building a solid shape model of a subject included in original images L1, R1, instead of using the morphing technique. The solid shape model may be built by obtaining corresponding points between original images L1, R1 and calculating the distances from the photographing positions to the corresponding points of the subject by the principle of triangulation based on the parallax between the corresponding points. Here, at the time of photographing, the aggregates of points on image projection planes (planes corresponding to imaging planes of CCDs 23A, 23B of photographing unit 2A, 2B) where straight lines connecting between each point of the subject and the focal points of photographing units 2A, 2B intersect become projected images, i.e., original images L1, R1. FIG. 6 illustrates the relationship between the solid shape model and image projection planes from which original images L1, R1 are obtained. Here, the solid shape model is a cube for the purpose of explanation. Accordingly, as illustrated in FIG. 6, interpolation images may be generated by setting a number of virtual image projection planes T corresponding to the number of interpolations (one in FIG. 6) between image projection planes of original images L1, R1 and obtaining a projection image to each virtual image projection plane T.

Motion picture generation unit 6 generates motion picture D0 by arranging original images L1, R1, and m interpolation images Hk (k=1 to m) in the order of viewpoint. The viewpoint order may be, for example, from right to left or vice versa.

File generation unit 7 generates three-dimensional file F0 for three-dimensional display by performing compression on image data of original images L1, R1 in JPEG compression format or the like. File generation unit 7 also generates motion picture file M0 by performing compression on image data of motion picture D0 in any of known compression formats, such as motion JPEG, MPEG, or the like. Further, together with these, file generation unit 7 generates relational information file R0 for relating three-dimensional file F0 to motion picture file M0.

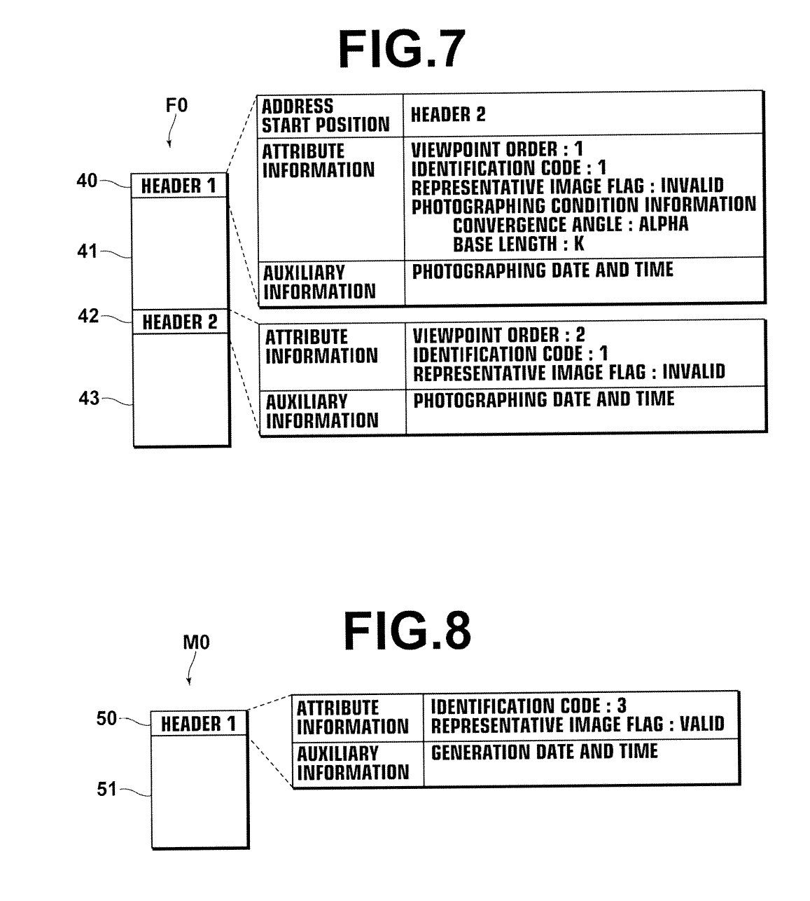

FIG. 7 illustrates a file structure of a three-dimensional image file of the present embodiment. As illustrated in FIG. 7, three-dimensional image file F0 includes header area (header 1) 40 for original image L1, image data area 41 for original image L1, header area (header 2) 42 for original image R1, image data area 43 for original image R1 arranged in this order.

Header area 40 of original image L1 includes an address start position, attribute information, and auxiliary information, as header information. The address start position is an address start position of header area 42 of original image R1 described as a list. The attribute information includes viewpoint order, image identification code, representative image flag, and photographing condition information. Here, the viewpoint order is an order when original images L1, R1 are viewed from left, that is, original images L1, R1 have viewpoint orders 1 and 2 respectively. The image identification code is information indicating whether the image stored in the image data area corresponding to the header area is an original image, an interpolation image, or a motion picture, in which image identification codes 1, 2, and 3 are given to original image, interpolation image, and motion picture respectively. The representative image flag is a flag indicating, when image file F0 is to be displayed in a thumbnail list with other image files, whether or not image file F0 is used as a thumbnail image. Here, the representative image flag is set to “invalid”. The photographing condition information is information of convergence angle α of photographing units 2A, 2B and base length K, and those stored in ROM 13C are used. Note that original image L1 has a viewpoint order of 1 and an image identification code of 1 representing original image. The auxiliary information includes information of the photographing date and time and the like.

Header area 42 of original image R1 includes attribute information of original image R1, that is, viewpoint order (=2), image identification code (=1), and representative image flag (=“invalid”) are described as the header information.

FIG. 8 illustrates a file structure of the motion picture file of the present embodiment. As illustrated in FIG. 8, motion picture file M0 includes header area 50 for a motion picture and image data area 51 for the motion picture arranged in this order.

Header area 50 for the motion picture includes attribute information and auxiliary information, as header information. The attribute information includes image identification code and representative image flag. Here, a value of 3 is allocated since it is a motion picture file. Further, the representative image flag is set to “valid”. The auxiliary information includes information of the generation date and time of the motion picture and the like.

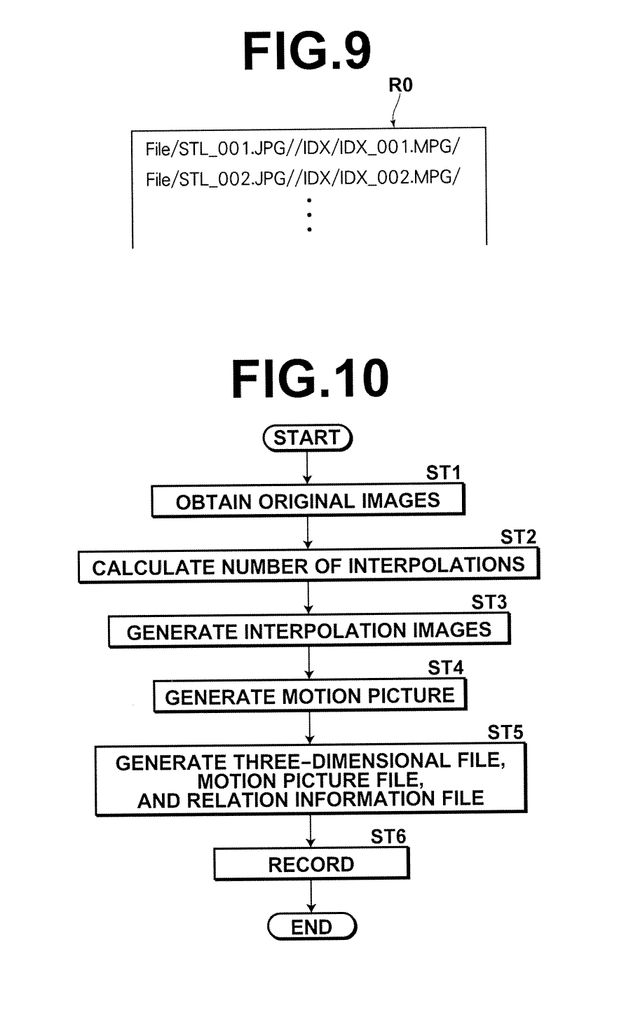

FIG. 9 illustrates a descriptive content of a relational information file. As illustrated in FIG. 9, relational information file R0 is a text file in which filenames of related three-dimensional file F0 and motion file M0 are described side by side. The filename of three-dimensional image file F0, letters IDX of indication of representative image, and the filename of motion picture M0 are described as a unit of related files. That is, by referring to the description shown in FIG. 9, it is known that three-dimensional image file F0 with a filename STL_{—}001.JPG is related to motion picture file M0 whose representative image has a filename IDX_{—}001.MPG, and three-dimensional image file F0 with a filename STL_{—}002.JPG is related to motion picture file M0 whose representative image has a file name IDX_{—}002.MPG. The descriptive content of relational information file R0 is updated every time three-dimensional image file F0 and motion picture file M0 are created. As the file name of the relational information file R0, for example, FL_MNG.TXT is used.

In the present embodiment, file names of three-dimensional image file F0 and motion picture file M0 are partially in common. Therefore, based only on the file names without generating relational information file R0, three-dimensional image file F0 and motion picture file M0 having a common file name may be related to each other.

Three-dimensional image generation unit 8 generates a three-dimensional image so as to be stereoscopically viewable on display unit 12 by performing three-dimensional processing on original images L1, R1. Although the type of three-dimensional processing depends on the manner of stereoscopic representation and whether or not display unit 12 is a 3D liquid crystal display, the three-dimensional processing may be implemented by differentiating the colors of a pair images (images of adjacent viewpoint orders) like, for example, red and blue and superimposing them on top of each other (anaglyph method), by differentiating the polarization directions of the pair images and superimposing them on top of each other (polarization filter method), or alternately combining, line by line, the pair images (parallax barrier method and lenticular method).

Frame buffer 9 is a storage unit for temporarily storing an image to be displayed on display unit 12.

Medium control unit 10 accesses recording medium 10A and performs read/write operations for three-dimensional image file F0, motion picture file M0, and relational information file R0.

Control unit 13 includes CPU 13A, RAM 13B serving as a work area when device 1 performs various types of processing, such as generating an interpolation image, to be described later, generating a three-dimensional image, generating an image file, displaying the three-dimensional image, and the like, and ROM 13C having programs that operate on device 1, various constants, and the like, and controls the operation of each unit of device 1.

Processing performed in the present embodiment will now be described. FIG. 10 is a flowchart illustrating the processing performed in the present embodiment for generating files. It is assumed here that motion picture reproducing time t has already been inputted from input unit 11. In response to an instruction to perform photographing from input unit 11, control unit 13 initiates the processing and photographing units 2A, 2B obtains original images L1, R1 respectively (step ST1). Note that image processing unit 4 performs image processing on original images L1, R1.

Then, interpolation image generation unit 5 calculates the number of interpolations m based on the value of t (step ST2), and generates m interpolation images from original images L1, R1 (step ST3). Then, motion picture generation unit 6 generates motion picture D0 from original images L1, R1, and interpolation images Hk (step ST4). File generation unit 7 generates three-dimensional file F0 from original images L1, R1, motion picture file M0 from motion picture D0, and relational information file R0 (step ST5). Then, medium control unit 10 records three-dimensional image file F0, motion picture file M0, and relational information file R0 on medium 10A (step ST6), and the processing is completed.

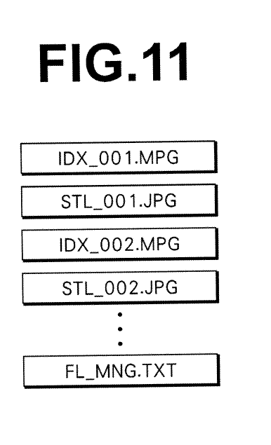

Note that three-dimensional image file F0, motion picture file M0, and relational information file R0 are recorded on medium 10A in the order shown in FIG. 11.

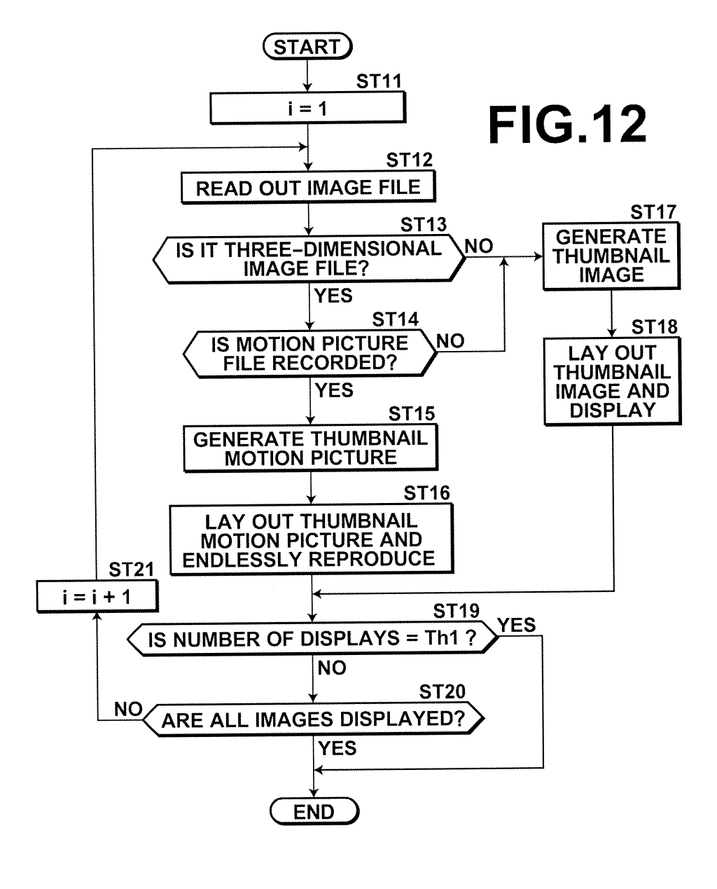

Next, processing performed, after various types of image files generated in the present embodiment, including three-dimensional image file F0 and motion picture file M0, have been recorded on the medium 10A, for displaying a list of thumbnail images of the images recorded on medium 10A on display unit 12 will be described. FIG. 12 is a flowchart illustrating the processing performed when displaying a list of thumbnail images. In response to an instruction to display a list of thumbnail images inputted from input unit 11, control unit 13 initiates the processing and medium control unit 10 sets the processing target file name to a first image file (i=1, step ST11), and reads out the target image file from medium 10A (step ST12).

Then, control unit 13 refers to the header of the readout image file and determines whether or not the readout image file is a three-dimensional image file (step ST13). If step ST13 is positive, control unit 13 refers to relational information file R0 and determines whether or not motion picture file M0 related to the target image file is recorded on medium 10A (step ST14). If step ST14 is positive, control unit 13 decompresses motion picture file M0 and generates a thumbnail motion picture for list display by reducing motion picture file M0 for the list display (step ST15). Then, control unit 13 lays out the thumbnail motion picture on the list display screen and reproduces endlessly (step ST16).

In the mean time, if step ST13 is negative, control unit 13 generates a thumbnail image of the image file (step ST17), then lays out the thumbnail image and displays on the list display screen (step ST18). If step ST14 is negative, the processing proceeds to step ST17.

Following step ST16 or step ST18, a determination is made as to whether or not the number of display thumbnail images or thumbnail motion pictures reaches a predetermined number Th1 that can be displayed on the index screen (step ST19), and if step ST19 is negative, a determination is made as to whether or not all images recorded on the medium 10A are displayed in the list screen (step ST20). If step ST20 is negative, the processing target is set to the next image file (i=i+1, step ST21), then the processing returns to step ST12 and steps from step ST12 onward are repeated. If step ST19 or step ST20 is positive, the processing is completed.

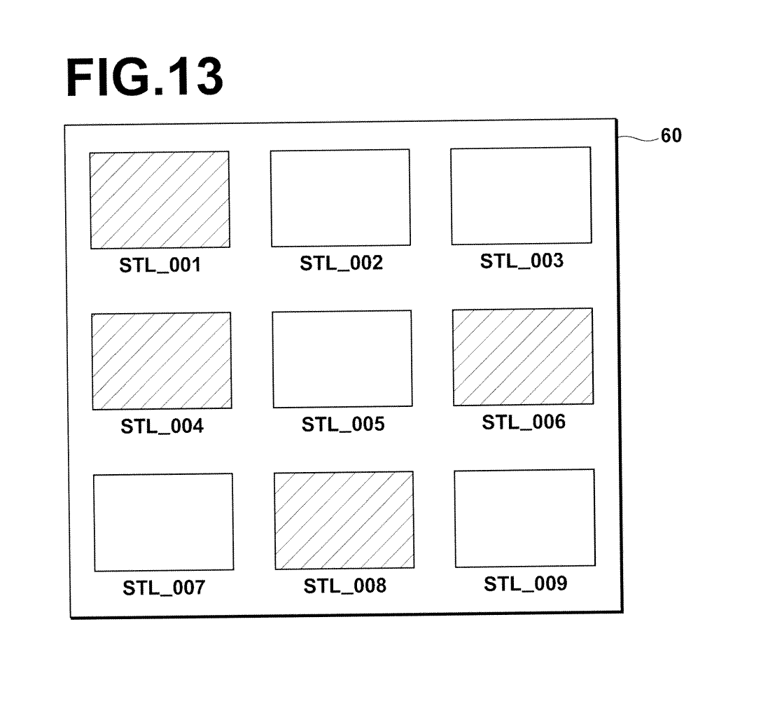

FIG. 13 illustrates a list screen of thumbnail images displayed by the present embodiment. As illustrated in FIG. 13, thumbnail images of image files recorded on medium 10A are displayed. Among a plurality of displayed thumbnail images, the one for which three-dimensional image file F0 is related to motion picture file M0, the motion picture is reproduced endlessly. In FIG. 13, thumbnail images for which motion pictures are reproduced are indicated by diagonal lines.

As described above, in the present embodiment, interpolation images Hk for interpolating viewpoint of original images L1, R1 are generated from original images L1, R1, then motion picture D0 in which original images L1, R1 and interpolation images Hk are arranged in the order of viewpoint is generated, and three-dimensional image file F0 and motion picture file M0 are related to each other and stored. Consequently, a motion picture is reproduced for three-dimensional image file F0 when a list of thumbnail images of image files recorded on medium 10A is displayed, whereby scenes in which viewpoints toward a subject sequentially vary are reproduced. This allows the user to easily recognize which one is a three-dimensional image from the displayed thumbnail image list, in particular when a plurality of three-dimensional image files F0 and two-dimensional image files are recorded on medium 10A in a mixed manner.

Further, the number of interpolation images Hk is determined such that the motion picture is reproduced for predetermined time t, so that the motion picture may be reproduced for the predetermined time.

Still further, original images L1, R1, and motion picture D0 are stored in different files, three-dimensional image file F0 and motion picture file M0, respectively, then three-dimensional image file F0 and motion picture file M0 are related to each other, and relational information file R0 having information indicating that motion picture D0 is the image representing original images L1, R1 is stored. This allows motion picture file M0 to be generated in a general file format which can be easily handled by a personal computer or the like. Therefore, the motion picture may be reproduced easily.

In the present embodiment, three-dimensional image file F0 and motion picture file M0 are stored separately, but a single file which includes imaged data of original images L1, R1, and image data of motion picture may be generated.

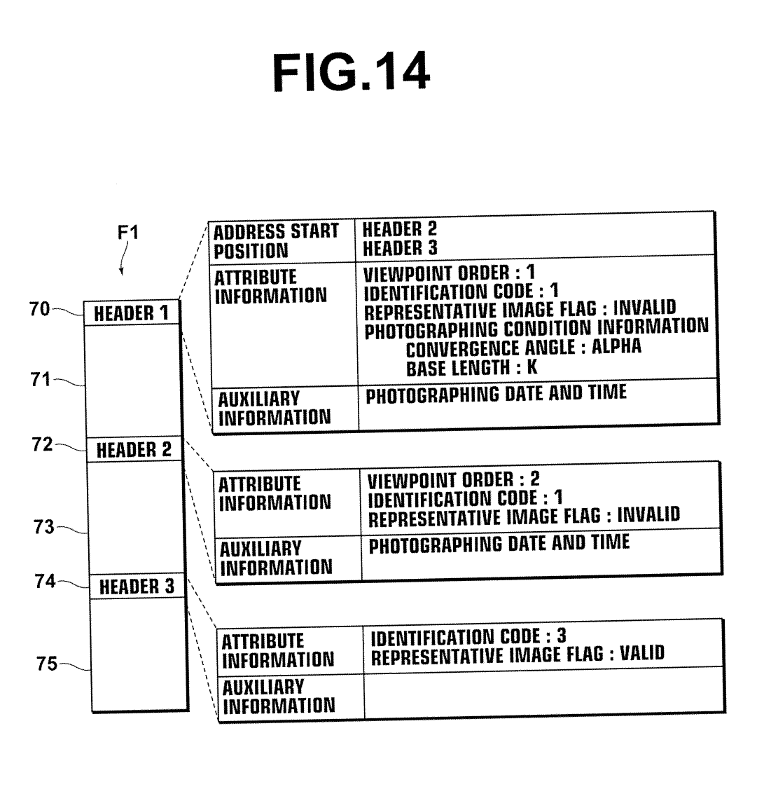

FIG. 14 illustrates a file structure of a file in which original images and a motion picture are stored. As illustrated in FIG. 14, image file F1 includes header area 70 (header 1) for original image L, image data area 71 for original image L1, header area 72 (header 2) for original image R1, image data area 73 for original image R1, header area 74 (header 3) for the motion picture, and image data area 75 for the motion picture arranged in this order.

Header area 70 of original image L1 includes an address start position, attribute information, and auxiliary information, as header information. The address start position is an address start position of header area 72 of original image R1 described as a list. The attribute information includes viewpoint order, image identification code, representative image flag, and photographing condition information. Here, the representative image flag is set to “invalid”.

Header area 72 of original image R1 includes attribute information of original image R1, that is, viewpoint order (=2), image identification code (=1), and representative image flag (=“invalid”) are described as the header information.

Header area 74 for the motion picture includes attribute information and auxiliary information, as header information. The attribute information includes image identification code (=3) and representative image flag. Here, the representative image flag is set to “valid”.

Even when original images L1, R1, and the motion picture are stored in a single image file, image file F1, in the manner described above, by referring to the descriptions of headers 1, 2, and 3 of image file F1 when reproducing thumbnail images, motion picture D0 having the representative image flag set to “valid” may be reproduced endlessly as a thumbnail image.

In the embodiment described above, the motion picture is generated following the photographing of original images L1, R1. It is also possible to read out original images L1, R1 recorded on medium 10A in advance and to generate motion picture D0.

Further, in the embodiment described above, original image file F0 and image file F1 include image data of only original images L1, R1, but the files may also include image data of interpolation images Hk.

Still further, in the embodiment described above, the image processing apparatus of the present invention is applied to a compound eye photographing device having photographing units 2A, 2B, but the apparatus may be provided as an independent unit. In this case, a plurality of images obtained by photographing the same subject at a plurality of different positions is inputted to the image processing apparatus, and original image file F0 and motion picture file M0 are created, as in the embodiment described above. Here, when generating interpolation images using not only original images L1, R1 obtained by photographing but also original images generated, for example, by computer graphics, original image file F0 and motion picture file M0 may be generated, as in the embodiment described above.

So far device 1 according to an embodiment of the present invention has been described, but a program for causing a computer to function as means corresponding to interpolation image generation unit 5, motion picture generation unit 6, and file generation unit 7, and to perform processing like that shown in FIGS. 10, 12 is another embodiment of the present invention. Further, a computer readable recording medium on which is recorded such a program is still another embodiment of the present invention.

1. An image processing apparatus, comprising:
an image obtaining means for obtaining a plurality of original images of a subject viewed from different viewpoints for generating a three-dimensional image;
an interpolation image generation means for generating at least one interpolation image from the plurality of original images for interpolating a viewpoint between at least the plurality of original images;
a motion picture generation means for generating a motion picture in which the plurality of original images and at least some of the at least one interpolation image are arranged in the order of viewpoint; and
a storage means for storing the plurality of original images and the motion picture in relation to each other.

2. The image processing apparatus of claim 1, wherein the interpolation image generation means comprises means that determines the number of interpolation images such that the motion picture is reproduced for a predetermined time.

3. The image processing apparatus of claim 1, wherein the storage means comprises means that stores the plurality of original images and the motion picture as separate image files with a relational information file that includes information indicating that the image file of the plurality of original images and the image file of the motion picture are related to each other and the motion picture comprises an image representing the plurality of original images.

4. The image processing apparatus of claim 1, wherein the storage means comprises means that stores the plurality of original images and the motion picture as a single image file together with information indicating that the motion picture comprises an image representing the plurality of original images.

5. An image reproducing apparatus for reproducing various types of images, including the plurality of original images stored by the image processing apparatus of claim 1,
wherein the image reproducing apparatus comprises a reproducing means for reproducing the motion picture when an instruction to perform a two-dimensional display is received for a three-dimensional image generated from the plurality of original images.

6. The image reproducing apparatus of claim 5, wherein the reproducing means comprises means that endlessly reproduces the motion picture.

7. An image processing method, comprising:
obtaining a plurality of original images of a subject viewed from different viewpoints for generating a three-dimensional image;
generating at least one interpolation image for interpolating a viewpoint between at least the plurality of original images;
generating a motion picture in which the plurality of original images and at least some of the at least one interpolation image are arranged in the order of viewpoint; and
storing the plurality of original images and the motion picture in relation to each other.

8. An image reproducing method for reproducing various types of images, including the plurality of original images stored by the image processing method of claim 7,
wherein the method reproduces the motion picture when an instruction to perform a two-dimensional display is received for a three-dimensional image generated from the plurality of original images.

9. A computer readable recording medium on which is recorded a program for causing a computer to perform an image processing method comprising the steps of:
obtaining a plurality of original images of a subject viewed from different viewpoints for generating a three-dimensional image;
generating at least one interpolation image for interpolating a viewpoint between at least the plurality of original images;
generating a motion picture in which the plurality of original images and at least some of the at least one interpolation image are arranged in the order of viewpoint; and
storing the plurality of original images and the motion picture in relation to each other.

10. A computer readable recording medium on which is recorded a program for causing a computer to perform an image reproducing method for reproducing various types of images, including the plurality of original images stored by the image processing method of claim 7,
wherein the image reproducing method reproduces the motion picture when an instruction to perform a two-dimensional display is received for a three-dimensional image generated from the plurality of original images.
